(19) United States
(12) Patent Application Publication
(10) Pub. No.: US 2018/0181667 A1
(43) Pub. Date: Jun. 28, 2018

(54) SYSTEM AND METHOD TO MODEL RECOGNITION STATISTICS OF DATA OBJECTS IN A BUSINESS DATABASE

(71) Applicants: Kurt Robert Kolb, burnaby (CA); Maziyar Hamdi, Vancouver (CA)

(72) Inventors: Kurt Robert Kolb, burnaby (CA); Maziyar Hamdi, Vancouver (CA)

(73) Assignee: 0934781 BC Ltd, Vancouver (CA)

(21) Appl. No.: 15/854,422

(22) Filed: Dec. 26, 2017

Related U.S. Application Data
(60) Provisional application No. 62/438,787, filed on Dec. 23, 2016.

(51) Int. Cl. G06F 17/30; G06Q 50/00

(52) U.S. Cl. CPC G06F 17/30867; G06Q 50/01; G06F 17/3053; G06F 17/30958

(57) ABSTRACT

A method and system are provided for analyzing content and social media to calculate a likelihood of a data objects being recognized by a user, particularly data objects related to business services, such as projects and company names. The system may model recognizability in absolute and personalized terms. A search engine returns search results including objects that are predicted to be highly recognizable.

### BACKGROUND

Search engines may be used by a user to find search results that match a search query and ranked by some algorithm to determine relevance. For example, a search engine may operate on a database of objects rank them by the closeness of that match. There are often too many search results that match the query to some degree. Thus the user must consume a large stream of data, looking for data that are relevant to their search.

Even when a particular object is selected by a user, the backend server will send all data associated with the object for display on the user's computer but there may be no ordering of such associated data.

The search engine may be a directory of businesses for identifying a set of businesses that matches query parameters such as location, size and industry. The associated data may include locations, clients, services provided and sample works.

### SUMMARY

This summary provides a selection of aspects of the invention in a simplified form that are further described below in the detailed description. This summary is not intended to limit the claimed subject matter's scope.

According to a first aspect there is provided a computer-implemented method comprising: identifying a set of first data objects that satisfy a search query; identifying second objects that are connected to the first objects in the database; calculating one or more recognizability metrics using a recognition model for the second object; ranking the first data objects based on the recognizability metrics of their connected second data object; and communicating a subset of the first data objects as search results based on the rankings.

According to a second aspect there is provided a computer-implemented method comprising: selecting a data object from a database comprising connected data objects representing projects, users, and organizations with respect to provision of business services; retrieving identification data from the data object; searching third party websites for content items comprising features matching the identification data; determining attributes of an audience of each content item; creating a recognition model from the aggregated attributes of the audiences and linking the selected data object with the recognition model in a database, whereby the recognition model calculates a recognizability score for the selected data object given attributes of a user or their search query.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

FIG. 1 is an illustration of connections between software modules of servers and client devices.

FIG. 2 is a block diagram of a computer system.

FIG. 3 is an illustration of a business graph.

FIG. 4 is an illustration of content items logged by a recognition module.

FIG. 5 is an illustration of a trend engine identifying trend topics and associating them with data objects.

FIG. 6A is a flowchart for processing content to calculate recognizability.

FIG. 6B is a table for storing a recognition model.

FIG. 7 is a flowchart for ranking results using recognition model.

FIG. 8 is a social graph of infected-susceptible nodes

FIG. 9A is an example website showing a search and search results.

FIG. 9B is an illustration of recognition applied to search results.

FIG. 10 shows sample time-series data for different trend classes.

### DESCRIPTION

In the present system, the inventors have appreciated that there is value is calculating whether one object is recognizable by a user, even without knowing or inferring whether a connection exists. A user of the present system may recognize a data object such as person, company, brand, or sample of work. This data object may be the primary object of the search or data that is connected in a graph database to the primary object sought. In one use case, the primary search objects are organizations, which are associated with sample work objects, client objects, and people objects in a graph sense. Thus the display of an organization may be personalized, based on data about the user or their organization, to show objects that the user is most likely to recognize. Herein re

A user may perform a search and view search results on a client-computing device, the results comprising representations of data objects from the database. The objects may be organizations (in the capacity of vendors, clients, or partners), past projects (sample work, awards, or case studies), documents (news, press releases, or blogs). No computer or person could know for certain whether each of millions of users will recognize any one of millions of objects, however, one aim of the present system is to calculate a likelihood that the given user will recognize a given data object. The most likely recognizable data objects are communicated to the client-computing device.

The search may be for a vendor organization, for which the search engine may return results for vendors that are recognizable or are connected to recognizable organizations or projects, preferably regarding a past provision of services. As a pervasive example here, consider the advertisement of “Mog the Cat” that was briefly popular in December 2015 for Sainsbury's stores (although the original book was written in 1970), produced by the agency AMV. A database may record connections between data objects, such as Organization.Sainsbury's, Organization.AMV, Project.MOGTHECAT, and Service.TVadvertising. These may be nodes in a graph connected by edges to show business relationships regarding providing business services. Whilst the AMV agency, with many others, may match certain search parameters there may be a time period and recognizable social proof for which this agency is the best search result because of its connection to a recognizable, trending ad.

Databases contemplated by the inventors may store hundreds of millions of users, millions of organizations, hundreds of thousands of projects and thousands of services. The present computer system and method are concerned with providing social proof of search result objects (hereafter first data objects or first organizations) by calculating the recognizability of other objects connected to the search result objects in a database. The search result objects may be organizations, such as vendors of business services. The other objects (hereafter second objects) may represent second organizations doing business with the first organization, past projects supplied by the first organization or received by a second organization, a brand or product of first or second organization, or people working for first or second organizations. These second objects provide a social proof of the first objects and are ideally recognizable.

As discussed in patent application U.S. Ser. No. 14/537,092, U.S. Ser. No. 14/937,203 and U.S. Ser. No. 14/690,325 and contemplated in the present system, the system may determine similarity between a buyer organization and client organization based on similarity of their attributes (e.g. size, location, industry). This similarity calculation may be used by the system to identify vendor organization that serve clients that are most similar to the buyer, as a proxy for capability, relevant experience and as a social proof.

However, similarity does not guarantee recognizability. A small restaurant in a large city is unlikely to recognize the name of another small restaurant in that same city, despite the firmographic similarity. Thus the social proof is diminished for a vendor supplying that similar, but unrecognizable client.

Whilst humans might rely on instincts and subconscious learning to say whether a company is famous, it is a non-trivial task to train a computer system to replicate this. Such a task is even harder when one must estimate whether a specific first party would recognize a specific second party. One goal of the present system is to gather data, build a model and populate a database about the fame, popularity or recognizability of organizations, sample work, brands, and people. Depending on the information provided about the user, the system may personalize the prediction of recognizability.

In the above example, the small restaurant may be heavily mentioned in popular media (broad recognizability) or only in foody media (niche, industrial recognizability). Moreover the user may or may not follow either medium so that user's own knowledge should be inferred.

In the present disclosure, the terms (and scoring of) “recognizable/recognizability/recognition” are used to capture the concept that the data object might be known to users, particularly in a given context. In some cases, the recognizability of an object may be passed to other objects connected to it. For example, a case study object about a viral commercial will have a high recognizability score, which in turn provides the associated brand with a high recognizability score, which in turn provides the company (and then parent company) with a high recognizability score. Thus recognizability may cascade through associated objects, decaying at further away objects and recognizability may also be aggregated or averaged from many associated objects.

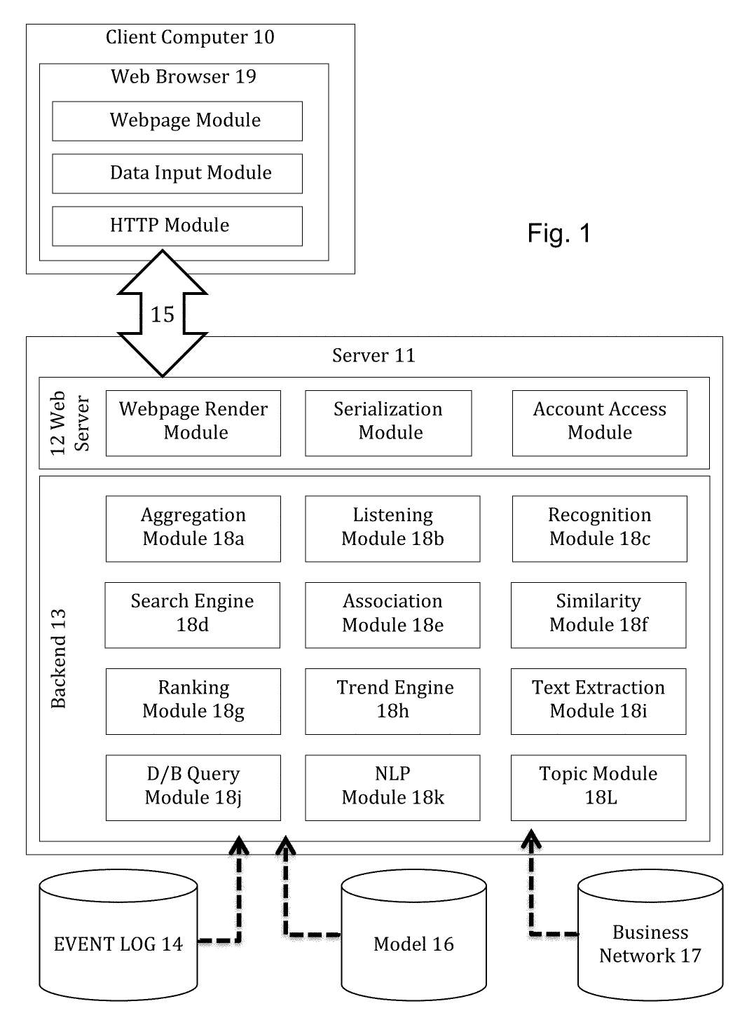

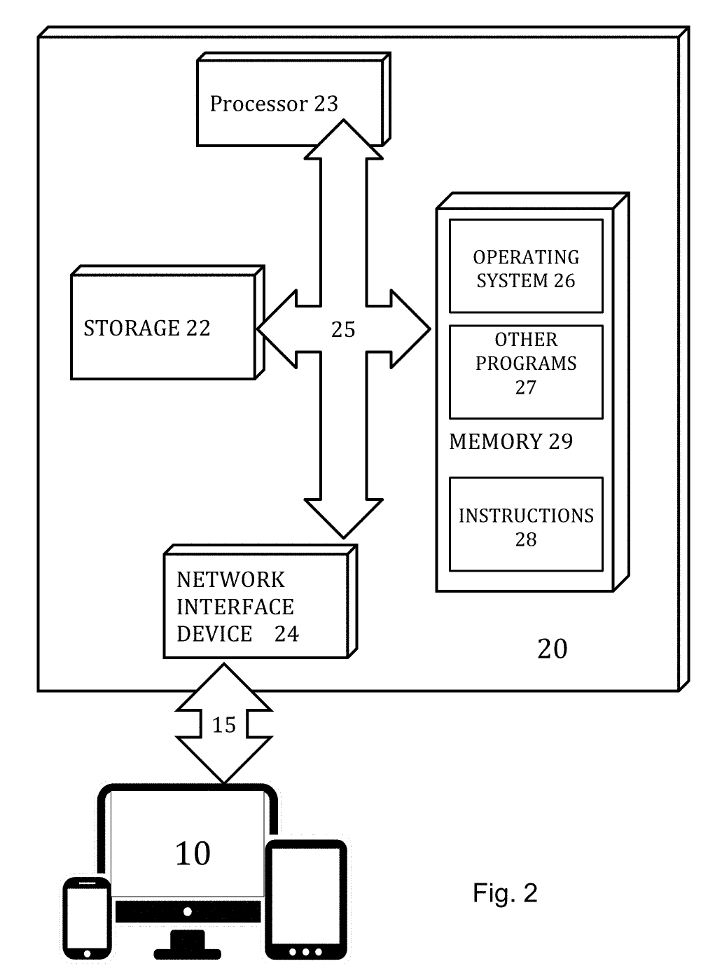

The present technology is implemented using computer systems and computer processing methods. FIG. 1 is an illustration of software modules and FIG. 2 is a block diagram of computing components provided in a system enabling searching and data processing.

FIG. 1 illustrates the interaction between user device 10 and the server 11 over network link 15. The devices 10 may communicate via a web browser 19 or smartphone APP, using software modules to receive input from the user, make HTTP requests and display data. The server 11 may be a reverse proxy server for an internal network, such that the client device 10 communicates with an Nginx web server 12, which relays the client's request to backend processes 13, associated server(s) and database(s) 14, 16 and 17. Within the server, software modules 18a-l perform functions such as, retrieve data, build and process data via service model(s), match requests and providers and calculate various score. Some software modules may operate within a notional web server 12 to manage user accounts and access, serialize data for output, render webpages, and handle HTTP requests from the device 10.

FIG. 2 is a block diagram of an exemplary computer system for creating the present system and performing methods described herein. The system 20 includes a bus 25 for connecting storage 22, non-volatile memory 29, one or more processors 23 and network interface device 24. The memory holds software instructions for the operating system 26, instructions 38 and other applications as may be needed. The network interface device communicates over the Internet connection 15 with client devices 10,

The one or more processors may read instructions from computer-readable memory 29 and execute the instructions 28 to run the methods and modules described below. Examples of computer readable media are non-transitory and include disc-based media such as CD-ROMs and DVDs, magnetic media such as hard drives, semiconductor based media such as flash media, random access memory, and read only memory.

Users may access the databases remotely using a desktop or laptop computer, smartphone, tablet, or other client-computing device 10 connectable to the server 11 by mobile internet, fixed wireless internet, WiFi, wide area network, broadband, telephone connection, cable modem, fiber optic network or other known and future communication technology using conventional Internet protocols.

The web server's Serialization Module converts the raw data into a format requested by the browser. Some or all of the methods for operating the database may reside on the server device. The devices 10 may have software loaded for running within the client operating system, which software is programmed to implement some of the methods. The software may be downloaded from a server associate with the provider of the database or from a third party server. Thus the implementation of the client device interface may take many forms known to those in the art. Alternatively the client device simply needs a web browser and the web server 19 may use the output data to create a formatted web page for display on the client device. The devices and server may communicate via HTTP requests.

The methods and database discussed herein may be provided on a variety of computer system and are not inherently related to a particular computer apparatus, particular programming language, or particular database structure. The system is capable of storing data remotely from a user, processing data and providing access to a user across a network. The server may be implemented on a stand-alone computer, mainframe, distributed-network or cloud network. Although example structures queries are shown in a particular format herein, it will be appreciated that other formats may be used using other query languages, such as GraphQL, OpenCypher, Gremlin, or SPARQL.

### Database

In certain embodiments, the present system comprises a database preferably arranged to capture business relationships between organizations, particularly with regard to professional business services. The system may be considered a business network, akin to social networks for people. The database includes different types of data object representing real world entities, such as, organizations, problems, solutions, projects, awards, content, and people. Data objects may store attribute values, images, documents, and tags. The database also stores connections (aka relationships, links, edges, associations) between two data objects. Data objects may have metadata indicative of some real-world understanding of the objects. Data objects may be tagged with features that are trending or connected to trend objects, which trend objects represent an identified trend.

A graph is an efficient structure to implement such a database, whereby nodes store profiles for people/organizations, content for projects/problems/solutions and edges record the connections between them. The connections may be undirected (e.g. ‘similar-to’, ‘coworkers’, ‘competitors’) or directed (e.g. ‘vendor-to’ and its inverse ‘client-to’). The system may be operated as a social network whereby users actively create connections and interact with other users.

A database system may comprise or be derived from multiple databases, possibly including third party databases. Each database may store its own graph shard to capture certain relationship types and having at least some users in common such that a database server can detect separate instances of a person on each graph, merge them, and analyze the mixed relationship modes between users across all graph shards. Sharding allows parts of a query to be divided up and run in parallel on different processors.

In the specification and drawings, an example graph implementation is shown, however, it will be appreciated that other data structures may be used to link problems, solutions, organizations, documents and past projects.

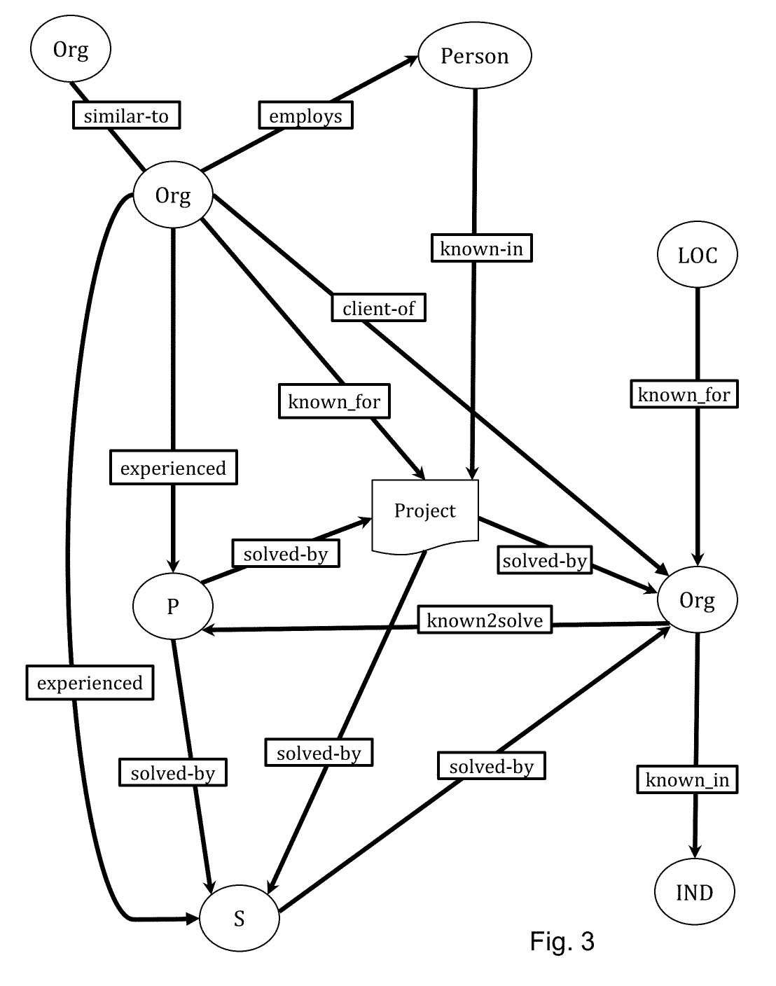

FIG. 3 shows an example graph with representative node and edge types (inverse edge are not shown here). Shown are the node types: organization (Org), location (LOC), industry (IND), problem (P), solution (S), projects and person. Connecting these nodes are the edges: solved-by, client-of, similar-to, office-of, industry-of, employs, and experienced. As shown, one edge type may be used between nodes of different types, in which case the search engine may return all the connected nodes, filter on certain node types, or separate by node type. This allows the search to be ambiguous with regard to the node to be returned. The node type may be discernible from a coded portion in the node ID.

In other embodiments, each pair of node types has its own edge type (e.g. organization-organization; organization-project; problem-solution, etc.) even to record similar concepts. This makes access time faster when the node type is known.

The database structure may include the following edges (with inverse equivalents) and representations:

Employs (inverse: is-employed-by) is a directed edge from an organization node to a person node and represents that the organization employs the person in real life.

Client-of (inverse: vendor-to) is a directed edge from a first organization node to a second organization node and represents that the first organization is a client of the second in real life.

Solved-by (inverse: solves) is a directed edge from project node, problem node, or solution node to an organization node and represents that the organization has provided services with regard to the project, problem, or solution. This may also be a directed edge between an project node and a problem node or solution node to represents that the real-life project demonstrates solving that problem using that solution.

Experienced (inverse: experienced-by) is a directed edge from an organization node to a project node, problem node, or solution node and represents that the organization has experienced requiring services with regard to the project, problem, or solution.

Office-in (inverse: office-of) is a directed edge from an organization node to a location (city or region) and represents that the organization has an office at that location in real life. The actual street address is stored in the organization record.

Has-industry (inverse: industry-of) is a directed edge from an organization node to an industry node and represents that the organization operates in that industry in real life. Details of its operation are stored in the organization's record.

Similar-to may be an undirected edge from a first organization node to a second organization node and represents that the first organization's firmographic data are similar to the second's. A ‘similar’ edge is useful for finding objects having a business relationship with companies similar to a named company. There may be a similar-to edge between project nodes representing that the cases solve similar problems using a similar solution. This edge may be calculated by the system's similarity module.

Known-for (or known_in or Known2Solve) is an edge used to indicate a degree of recognition of one node in the context of the other (shown as ‘known-for’ labels in FIG. 3). The edges indicate that a data object (person, organization, or project) is known in the context of the connected second object (location, industry, problem type, solution type, project, person organization). The inverse edges may also be recorded for the search engine to identify data objects that are recognizable from a starting feature or object. A non-exhaustive mixture of node types is shown in FIG. 3.

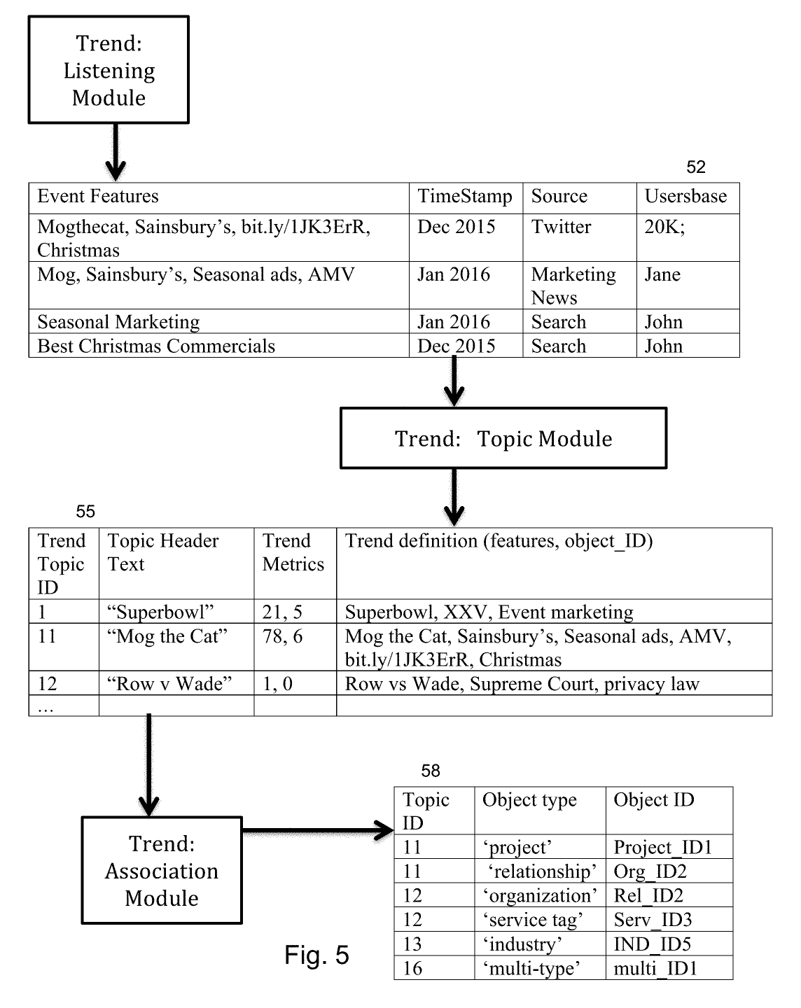

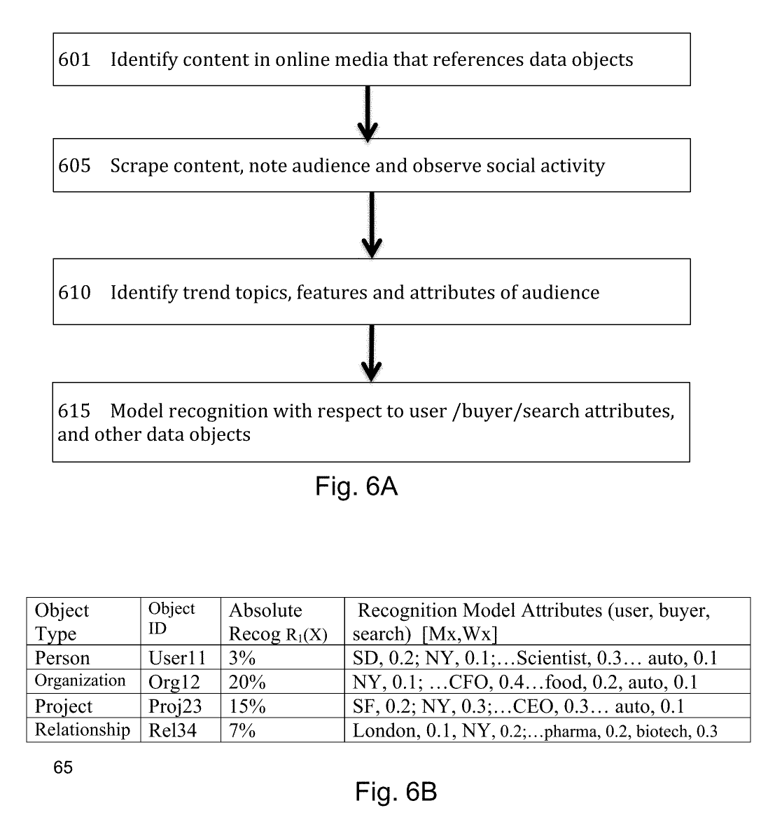

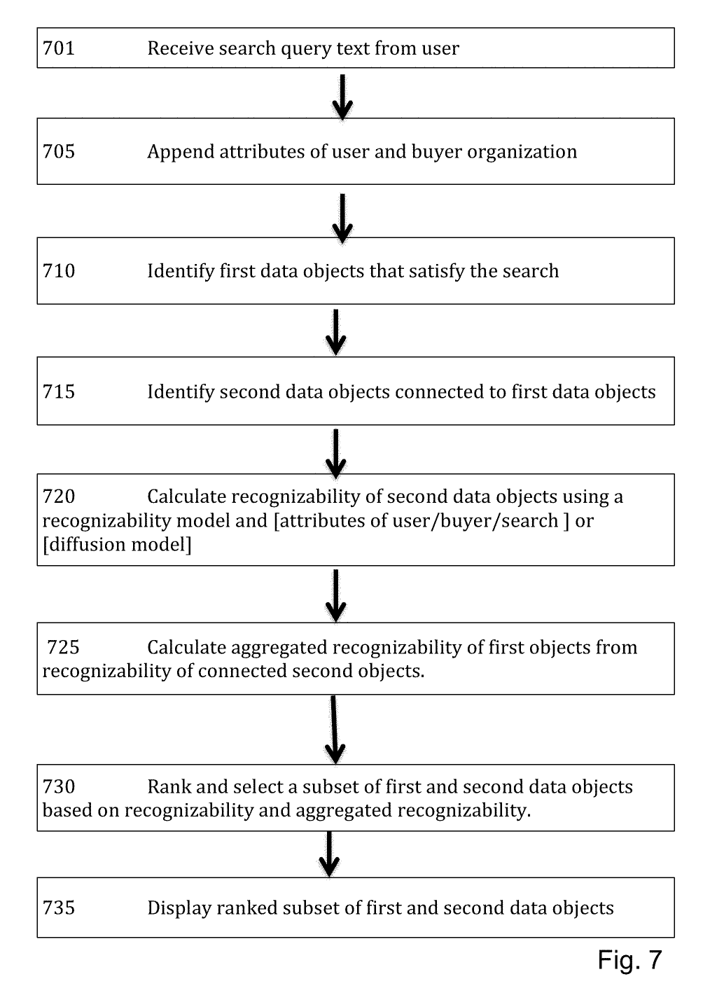

The system may record trend and recognizability data in tables, relational databases, or graphs, all of which are referred to here as databases. FIGS. 5 and 6B provide examples of trend databases for event logs 52, trend topics 55, associated trending objects 58 and recognizability 65.

The system may make data available using indices and inverted indices, such that the search engine can identify one or more data objects to display given user/buyer/search attributes, trend topics, connection type, or object type.

Attributes such as location and industry may be stored with each organization object. However, these are popular search parameters and thus it is efficient to create node types for large cities/regions and general industries. The exact office address and industry description can be stored with the organization object.

Alternatively a graph database may have native processing capabilities and index-free adjacency. Thus each node directly references its adjacent nodes, acting as a micro-index for all nearby nodes. Index-free adjacency is more efficient than using global indexes, as query times are proportional to the amount of the graph searched, rather than increasing with the overall size of the data.

### Data Gathering and Sources

A data-gathering module may gather data about each data object to determine the scope of its recognizability and scope of knowledge of users. The data may be gathered from third party data sources such as social networks, social media, online news and journals. The data may be gathered from a database within the present system, whereby behaviour and user accounts are more closely monitored to observe associations and recognition.

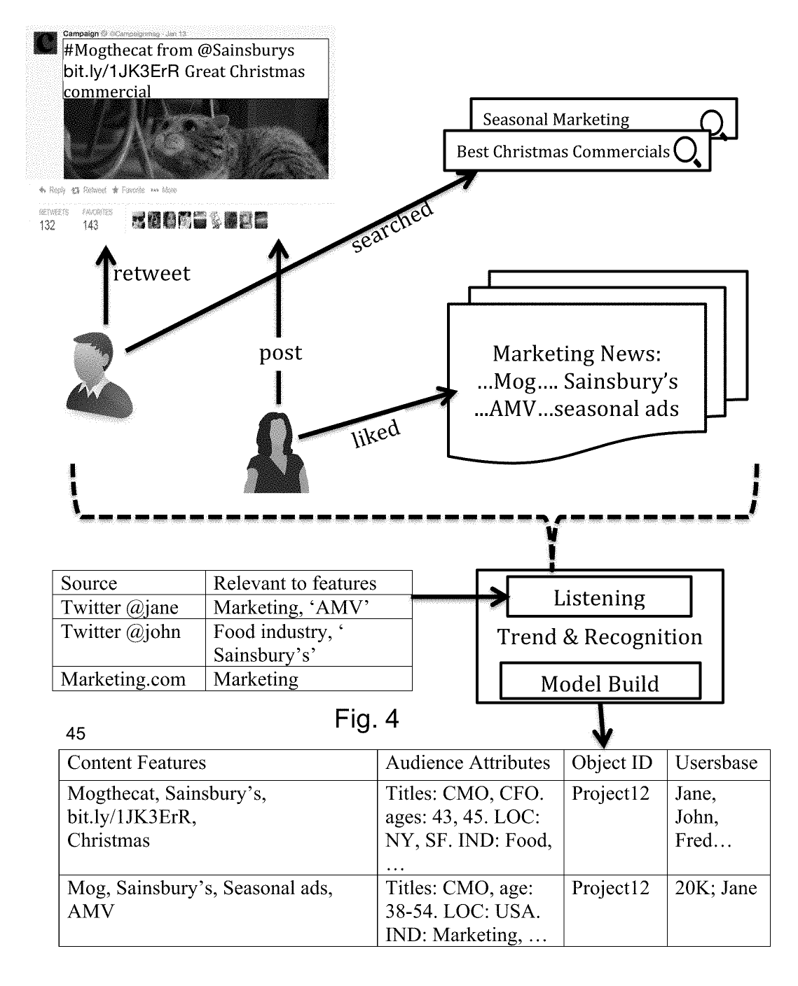

The data gathering module preferably starts by selecting data objects in database 17, using their identifying features to search online data sources for content. Alternatively, as shown in FIG. 4, the data-gathering module may listen to preselected data sources for mention of features related to data objects in the database. Features for a content item may include words, n-grams, numbers, tags, metadata, URLs, or features extracted for images and videos. Preferably the system processes these features to identify the most meaningful features by using known techniques such as TF-IDF, stopword removal, stemming, and Named Entity Recognition.

The data objects may represent products, organizations, people, or projects, and be identified by names, brands, titles or keywords. Preferably the data objects are co-mentioned with other features or data objects in the database 17 to provide context for the recognizability. For example, many journals focussed on a particular industry or location may discuss the product launch of a brand. The model records that the brand is recognizable in the context of product launch services, particularly to users within that location or industry.

The following are examples of data to be gathered:

Content in social media, such as blogs, tweets, posts, videos;

Content in online news, industry journals;

Social media influence of a person or organization interacting with each content, measured by the number of tweets, retweets, likes, video views, blog subscribers, followers and size of their social network;

Social media scope of the buyer, such as the number of tweets, retweets, likes, video views, affinity group subscriptions, accounts followed and size of their social networks;

Popularity and demographics of the content or its publisher;

Time-series of events regarding user-interactions with content;

Awards won by each organization for projects;

Professional profile of a user or their organization to determine demographics and firmographics such as user's age, affinity groups, job title, profession, education, locations, industries, and organization size;

Crowd sourced opinions about organization from websites, such as Owler, Crunchbase, product review sites, and stock analysts, especially with respect to assessing competitors, specialties, products, and projects; and

User behaviour with respect to an object such as requesting extra details about the object, ‘liking’ ‘following’ or ‘sharing’ the object in social media.

The system may comprise a Listening Module that reads content from social media, social networking, online news and blogging sites. The content may be messages, video, images, documents that are sent, broadcast, posted, viewed, Tweeted, Retweeted, ‘Liked’, or saved by users or shared between users. Exemplary websites for such content include Twitter, Linkedin, Facebook, Quora, Crunchbase, online news and journal publications. The content may be collected by a feature-engineering tool to transform raw data from these websites using APIs or scraping to gather features. FIG. 4 illustrates various sources of content and user-intereaction that are monitored by the Listening Module in order to add recognizable features to recognizability table 45.

### Recognition Model Building

A statistical model may be built from multi-factorial considerations to calculate a likelihood of recognizability of a data object. Depending on the information available, the model may move from generic recognizability to a highly personalized likelihood of recognition. The Recognition Module may consider the following for each object:

(1) Absolute recognizability of the object from all media.

(2) Trending and recency of events for the object.

(3) Recognizability of the object given attributes of a user, buyer or search query.

(4) Diffusion through a social network of the object in general and with respect to a given user.

(5) Estimating the scope of a user's knowledge about any objects.

(6) User-behavior with respect to objects on the system.

(7) Similarity of the object to other objects that are connected to the user.

Consideration 1 above provides a naive, absolute recognizability likelihood to all users for all search contexts. This recognizability R₁(X) of object X may be calculated from the number of content items in general media (e.g. online newspapers) or social media that discuss data object X (typically by one of its identification features). The absolute recognizability contribution of each content item is proportional to the audience size of the content item or the publication in general. The audience size (Audience, for each content item i) may be measured by the number of subscribers to the publication, a count of content access from social media sites (e.g. YouTube views, ‘retweets’, Google rank, or Alexa Rank for traffic. These total viewers may be normalized by a constant

R₁(X)=1/K₁×ΣAudienceᵢ Eq. 1

The absolute recognizability may be stored with each object in the database, where the value may represent the likelihood of any user recognizing the object. Table 65 in FIG. 6B shows absolute likelihood of anyone knowing an object.

(Consideration 2) The absolute value may be increased by a trend factor of each object when a significant variation is detectable in time from a baseline. The model may calculate a trend factor for X (Trendₓ) from the first derivative of these counts with respect to time, or fit a curve, or apply an exponential decay to account for recency after individual events.

R₂(X)=Trendₓ×R₁(X) Eq. 2

(Consideration 3) Knowledge of the user leads to a better estimate of that user recognizing a given data object. The recognition module may thus include a modeled recognizability function for object X and user Y using attributes of the user, their employer and/or their search. In one embodiment, the model may calculate a conditional recognizability R₃(X|Y) of objects X given knowledge of User Y. User attributes may include locations, job titles, industries, education, organization size, and age. The module may store the model for Object X as vector [Mx], weighted by vector [Wx]) and compile a user vector [Y] of attributes, including the personal/professional attributes (denoted Attributesᵤₛₑᵣ), employer/buyer firmographics (denoted attributes_{buyer}) and search attributes (denoted by Attributes_{search}).

Table 65 of FIG. 6B, shows the modeled, weighted set of recognition attributes for several data objects, shown as pairs of attribute values and weights. The table shows a short set of relevant attributes only, which can be converted to a sparsely populated vector of all attributes.

The weights provide both the relative relevance of attributes and absolute likelihood of recognizability. Some modeled recognition attributes, such as the location(s) or industry(ies), may also be attributes of the user, buyer or search. This will depend on what is known about the user, their employer (buyer) and their search. Alternatively, the model repeats these attributes for each of user, buyer or search. There may be multiple attribute values for certain attributes, e.g. the location from the IP address of the device, user's declared location setting, user's education location, user's previous job location(s), buyer organization's offices, and search location(s). In this case, each of the location values increases the likelihood that a data object will be recognized. Several different functions may be used to compare these features. For example the equation may be a product of the weight, model feature vector and the combined attributes of user, search and buyer:

R₃(X|Y)=[Wx]^{T}[Mx][Y]

[Y]=([Attributesᵤₛₑᵣ]+[Attributes_{search}]+[Attributes_{buyer}]) Eq. 3

In another embodiments, the weighting function may be a weighted sum of similarity functions, which functions vary by attribute type, e.g. location similarity is measured by distance and job titles similarity is found from a title correlation matrix. Each model feature in Mᵢ is compared to Attributeᵢ and multiplied by weight.

R₃′(X|Y)=ΣWᵢ×Similar(Mᵢ,Attributeᵢ) Eq. 4

The weights may be used to calculate an independent likelihood of an object being recognized for a user based on one matching attribute. The total recognizability based on all attributes likelihood may then be calculated using a Bayesian Approach.

The model may be with respect to a data object if that direct information is known or with respect to a content item or publisher of content items. The audience of the content or publication provides demographic information about the type of person that reads the publication or have viewed the content item. For most online publications, the demographic distributions are known (i.e. the breakdown by age, gender, location, profession, etc). For niche publication (industry-specific journals/blogs) the demographics/firmographics of the viewers may be similarly narrow, e.g. patent lawyers reading patent law blogs. In social media/social networks, individual viewer's demographic are often known and used to determine an exact distribution of demographics/firmographics for every content item.

In some cases, information about recognizability of an object is unknown but the audience of the publisher or of a content item might be known. This recognizability information may cascade to names mentioned in the content or publisher. A publisher's modeled attribute vector [M_{P}] is multiplied by the likelihood that a person would have viewed content i, given that they read the publication. A content item's vector [Mc] is multiplied by the probability that a person would recognize object X, given that they viewed content Ci. This is efficient for storage and processing, as a publication will have many content items and content items may mention many data object, whereby the publication model vector may be reused for each content item (and a content model vector may be reused for each object referenced therein)

In another embodiment, the recognizability may be modeled with a graph data structure whereby a directed edge between a data object and another object or a feature object (e.g. a location node, service node, and industry node) represents a binary or scored likelihood that the first data objects is recognizable in the context of the feature object or other data object. The recognition module identifies these associations, aggregates them, and stores them in the database. Thus the Recognition Module need only traverse the graph from a given First Object to identify all Second Objects and features for which the First Object is likely to be recognized.

This graph representation is different from the factual existence of a company at a given location. Instead it can be considered as indicating how well associated/known an organization is with a given location, within a given industry, with respect to providing/receiving a given service, or in connection with a project or other organization (e.g. Coca Cola is known for receiving marketing services, Alice Corporation in known with respect to patent litigation, or Enron in known with respect to accounting services).

(Consideration 4) The recognition module may create an infection or diffusion model, with regard to knowledge of data objects, such as people, organizations and projects. Infection may be estimated by considering the social network of the user. Here the assumption is that the user is likely to recognize a name if many contacts of the user know the name. Actual knowledge by the user's contacts may be determined by analyzing the organizations for which they have worked, volunteered, followed, applied to, tweeted, retweeted, or direct messaged. Similarly, the blogs, tweets, or articles viewed may be scraped to determine what names and projects that they would have read and likely still recognize.

The infection function for object X in a social network produces a likelihood of recognizability for user Y written as:

R₄(X|Y)=αΣinfected_{z}×W_{y,z} Eq. 5

Where Wy,z is the strength of a social relationship between users Y and Z in the social network, alpha is the contagion coefficient, and Infected_{z} indicates whether another user Z is infected (or likely infected) with the knowledge of object X. The calculations may be recursive to calculate infection from contacts that are two or three hops away. Thus the model calculates the likelihood of recognizability of a name rather than estimating that the user has an actual connection with the data object.

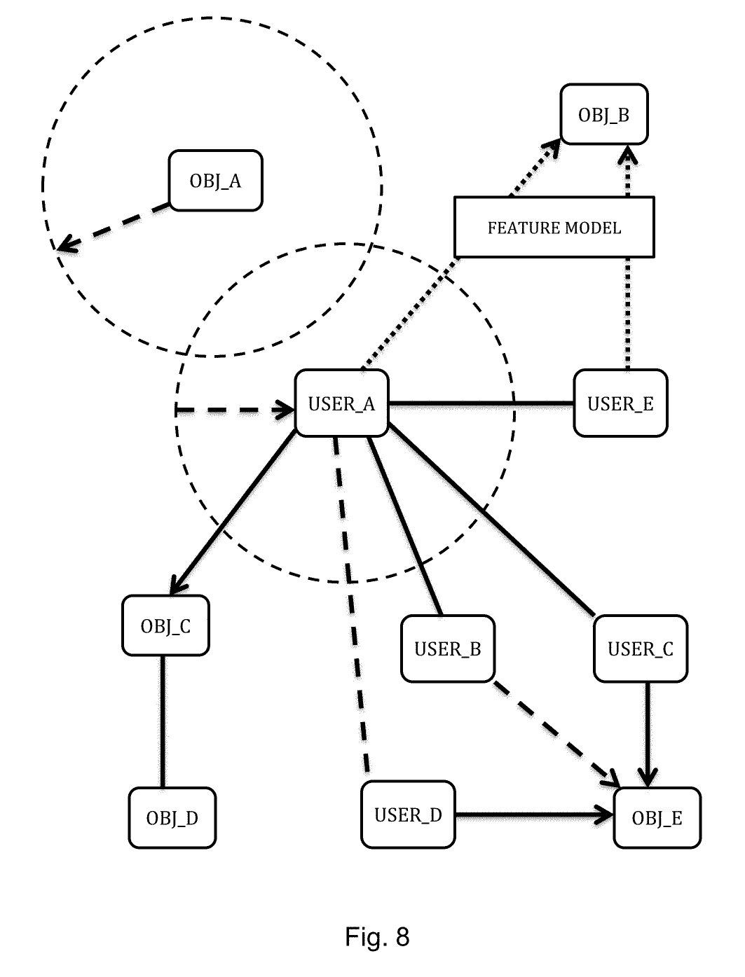

Infection may also be modeled from an inferred social network, that is a network without explicit connections. The inference may be made from similarity of user attributes, their mutually read content, and their mutual groups, etc. FIG. 8 illustrates by dotted lines an inferred connection between User A and User D.

Information diffusion is further detailed in “Interactive Sensing and Decision Making in Social Networks” https://arxiv.org/pdf/1405.1129v1.pdf, incorporated herein by reference, particularly pages 71-83. Other techniques for creating a diffusion model are further discussed in: “Influential Nodes in a Diffusion Model for Social Networks” https://www.cs.cornell.edu/home/kleinber/icalp05-inf.pdf. The book “Social and Economic Networks” M. O. Jackson 2008 provides further discussion.

Thus to predict infection, the model does not need to know the actual path between infected users and a susceptible user, only whether there are a number of infected users near the susceptible user.

Infection thru a social network is discussed in more detail at http://www-cs.stanford.edu/people/jure/pubs/connie-nips10.pdf

Consideration 4 and 3 may be combined where the data does not confirm that a social contact is infected with knowledge about a data object, such as User B and Object E in FIG. 8. For each social contact Z, the recognition module computes a likelihood of recognizing object X P(X|Z), using equation 3 or 4. Then the infection model calculates the likelihood of a user being infected from their social contacts. Equation 5 is modified to account for the uncertainty of infection by multiplying each infected user Z by its own P(X|Z).

(Consideration 5) In addition to determining the distribution of a data objects, the model may take into consideration the scope of knowledge of the user. This enables the model to account for users with similar attributes of other users but different viewing behaviour and social engagement. Thus the recognition module analyses the social network of the user, calculates a user knowledge score based on the number of network connections of the user, particularly outbound/reciprocal edges such as friends, likes, posts, views, etc. The score is preferably a weighted sum of edge counts, weighted by edge type, which weight may be stored in a lookup table. This score may be viewed as an absolute scope of the user's knowledge of any object, rather than what specific knowledge they have.

R₅(any object|Y)=K₅/NumObjects×Σ_{i=outbound edges}LookupWeight(edgeᵢ) Eq. 6

where NumObjects is the number of objects in the database and K₅ is a constant to reflect empirical evidence of recognition, and LookupWeight is a function that returns a weight for a given edge based on its type.

The analyses may further include a user knowledge model to improve on the naïve knowledge score based on the attributes of the people and objects connected to user Y. For each edge i, the recognition module determines features of the connected data object to build a feature vector for user knowledge and aggregates the features (optionally weighted by edge type). Thus a user that posts articles about tax accounting in New York will have a knowledge vector heavily weighted around the text features “tax accounting” and “New York,” implying specialist knowledge with respect to objects having these features too. The user's knowledge vector may be multiplied by the data objects vector to calculate a likelihood of recognition R₅(X|Y).

(Consideration 6) In one embodiment, the modeled prediction of recognition is highly personalized by monitoring each user's behavior on the system. The system may monitor the user's interaction (clicking-on, mouse-hover-over, or scrolling to view the evidence) with data objects in general and then record this as recognition of the object X′. The recognition module may predict recognition R₆(X|(R(X′)) of object X that the user might recognize given the recognition of object X′. The additional objects may have attributes or text features similar to the recognized object.

(Consideration 7) The recognition module may also calculate recognizability of some data objects based on their similarity to other objects that are connected to the user in the database. In this case, similarity is preferably calculated by comparing the data source of each object, (known or expected) audience demographics, keywords or features in the content, and publication dates. The recognition module thus infers that a user that is recorded to have viewed one content item is likely to have viewed a similar content item from a similar source, within a similar time frame.

These considerations are illustrated in FIG. 8 by a social graph. Here the user of interest, User_A, is socially connected to other users B to E and some users have viewed objects C and E. The absolute recognizability of Object A is indicated by its circle with a conceptual (outward) radius of being recognized. User_A's scope of knowledge is indicated conversely by a dotted circle with a conceptual (inward) radius of objects recognized. An intersection indicates conceptually that User_A's scope of knowledge includes Object A.

Object B has no known connection in the graph but the model uses the attributes of the user to determine the likelihood of User_A recognizing Object B.

Object C is recorded as connected to and thus recognized by User_A. Additionally Object D has features similar to Object C and thus has a likelihood of being recognized, proportional to their similarity. Conversely the fact that the user does not know Object F (not shown) which is similar to Object D, reduces the likelihood of recognizability, proportional to their similarity. Positive and negative knowledge may be weighted and summed to get a total recognizability score.

Object E has no direct connection to User_A, however three (Users B, C, D) of her friends are infected (or likely infected) with knowing Object E (thru views, posts, Likes), each friend edge providing a possible infection path, with a chance of infection proportional to the social strength score.

The skilled person will appreciate that the above considerations may be combined to calculate a total recognizability score for any object and that different considerations of the model may be used at different stages of a search and ranking process. For example, a set of objects may be evaluated for recognizability, whereby the recognition module first accesses each data objects absolute recognizability score and continues evaluating only those above a threshold amount. A first set of models may be built for each consideration trained on positive and negative recognition data. Then a second model may be trained on the aggregate of the first models to calculate a combined likelihood of recognition.

The skilled person with appreciate that there are several ways to create models for each of these considerations. The model form may be a linear or nonlinear algorithm of user attributes and data object attributes, or may use machine learning techniques, such as neural nets, Naïve Bayes and Logistic Regression The training data set preferably includes both positive and negative recognition training examples of users recognizing and not recognizing data objects. Then the model can be used to generalize recognition for all users and all objects. The equations will comprise weights and normalizing constants that can be optimized to minimize the error in the training data.

One way to gather training data is for the system to survey users thru the UI about their recognition of brands, organizations, projects, and projects and then train the model on the survey data.

Certain considerations of the model will be used or ignored depending on what data is available, such as the user's attributes if they are logged in to the system, buyer organization's attributed if they are known, and the richness of the search query.

The data is preferably collected, recognizability modeled and stored in an offline process to be used in real-time during search and ranking.

### Database and Recognition Model Access

The business database 17 may be accessed remotely by users through a search engine operated via a User Interface (UI). The user may search for an organization by attributes such as their firmographic data, services offered, or connections to other data objects. One use of the disclosed methods is a website for an organization as a buyer searching for another organization to provide them with services, particularly professional business services. One improvement over existing directories is that the proposed system is able to provide social proof for the search results by displaying evidence objects that are connected to the search results AND recognizable by the user.

The search engine receives a search query comprising a text string or selected attributes. Preferably user attributes are added to the query, either explicitly entered by the user or automatically added by the search engine from data in the user's accounts. For example the user may create an account and provide certain data about themselves and their employer as well as link their account to their Linkedin account which contains their professional data.

The search engine may use Natural Language Processing, Named Entity Recognition, and a grammar to create a structured query as discussed in U.S. 62/406,418 filed 11 Oct. 2016 and incorporated herein by reference.

The search engine retrieves data from first data objects that satisfy the search query, ranks the objects according to the degree of match and/or relevance to the user, then selects certain objects (of the first data objects) to be display as search results. See U.S. Ser. No. 14/537,092 filed 10 Nov. 2014 for more details.

The recognizability model may also be used to populate confidence values in a Named Entity Recognition model, whereby candidate interpretations for features in search text string are increased for those that are highly recognizable.

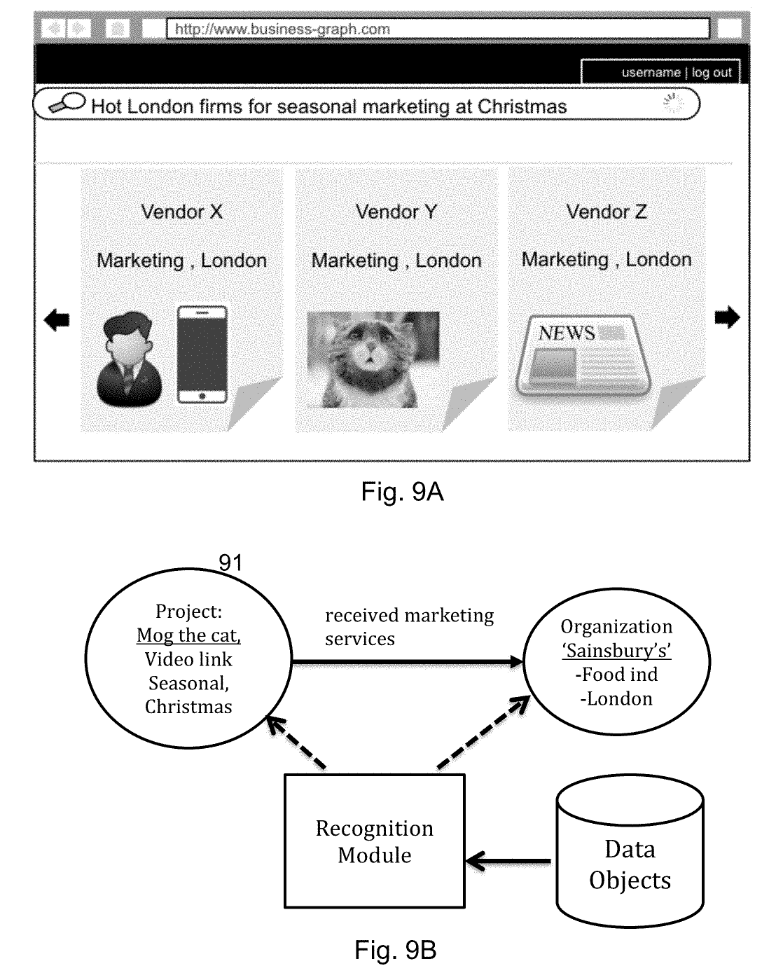

For some first data objects, the search results, such as those highest ranking or selected by a user, the search engine identifies data objects (second objects) connected thereto. Second data objects provide social proof and context of the first data objects in the search results and are identified to the user based on the object type (e.g. brand name, client organization name, or past project name) and the connection type (e.g. there has been a past provision of services with regard to the second object). FIG. 9A shows three vendor organizations that satisfy the search query, the vendor objects being connected to several second objects as social proof of providing services. Some of these second objects are more recognizable to the user than others, as estimated by the Recognition module in FIG. 9B.

The recognition module evaluates the recognizability of the second data objects in order to rank them for display to the user. The search engine may rank first organizations based on which have the most connections with second data objects that are highly recognizable by the user. This ranking may be a count of second objects with a recognizability score (or an aggregate of recognizability scores) above a threshold. The skilled person will appreciate that other algorithms may applied to generate recognizability metrics for each first data objects from a plurality of scores from connected objects.

In other embodiments, the recognition module is used by the display module to select second data objects to display. In this case, for a given first organization, the display module selects second data objects for display at least partly based on their own recognizability score. The selection may be segregated by data object type, such that the most recognizable clients are shown in addition to (not competing with) the most recognizable people, brands, sample work, or people. Therefore the first organization may be selected using the same means as the second objects to display.

The display module may also be programmed to select second objects for display that are connected with other highly recognizable objects. This may be the case where the predicted recognizability is with regard to one or more of a brand, person, organization, or sample work but another of the brand, person, organization, or sample work is to be displayed. The appropriate database connection enables the module to select one object when it is the connected objects that is recognized. The display module may consider the average, aggregate or maximum of recognizability probabilities of connected objects.

### Trend Engine

As discussed above, an absolute recognizability score may be modified by a trend metric indicating whether the data object or feature is growing or declining in recognizability. In the context of a business platform, trends may represent new products, popularity of business services, technology adoption, best business practices, influential business people, or new projects performed by organizations. One aim of the present system is to relate a trend to data objects stored in the database, such that the system can identify objects that are trending. A real-world trend may be represented as a trend topic in the system, which is defined by one or more text features or links to data object. For example, one trend topic may be defined by the text features “Mog the Cat”, “Christimas Ad”, “Sainsburys” as well as a link to the organization object for “Sainsburys Ltd” and to the project object for the past advertisement video.

The number of all documents on social media requires huge computing resources to process them and tends to produce a broad range of noisy topics irrelevant to the types of data searched for on the present system. Thus the listening module preferably listens in a first instance to a first set of data sources that are relevant to data object types in the database, such as specific user accounts, forums, groups, and industry journals. In the business services case, the sources may be online business service journals, Twitter accounts and hashtags of businesses, groups dedicated to professional services, and websites for viewing projects stored in the business database.

The first set of sources may be identified using experts or a machine classifier that compares attributes of the data sources and attributes of data objects. Such attributes may include job titles of accounts, industries of organizations, services/product classes of vendor organizations. The classifier may further determine whether the documents for a candidate source comprises features that are indeed relevant as classified. The system may record the first set of sources in table 52 (see FIG. 5) along with features for which each is relevant. The trend engine may use this relevance when calculating the likelihood that a topic is associated with a data object. For example, a topic may be identified from social media activity on several accounts deemed relevant to marketing (e.g. because the accounts have marketing job titles). Therefore the trend association module increases the association score for associating this topic with data objects that are tagged with ‘marketing.’

Once the trend engine identifies a potential trend within the first set of sources, it may listen for further event data about that trend amongst a second set of sources having less or no relevance to the attributes of the potential topic. This helps to remove noise and consumer trends from the wider audience, whilst using the big data available once a trend is identified from the smaller data set.

The trend engine may use topic modeling techniques to identify that a plurality of features and objects are related to the same trend topic by processing events and noting co-occurrence of features/objects. For example, certain documents may mention two or more features or links to objects, which indicates that they may be related in the minds of users. Topic modeling determines a distribution over many features, such that belonging to a given topic is a likelihood rather than a binary comparison.

The trend engine may also look for overlapping time-series data. The 3-gram “Mog the Cat” trended in 1970, 2004 and December 2015, however, the latter trend was anomalous being briefest in time/greatest in magnitude and the only time that the time series metrics coincided with the metrics of other features of “Sainsbury's”, “Christmas”, “Seasonal marketing”, and the video object. Those other features have their own time series analytics (e.g. “Sainsbury's” being constant and “Christmas” being cyclical), from which the trend engine detects anomalies or trend metrics that coincide with “Mog the cat.” The trend topic module thus compares similarities in trend metrics and temporal overlaps of two or more features to determine a confidence that they are related to the same topic. Preferably this is done amongst features that are already identified as potentially related to the same topic.

As shown in FIG. 5, the topic module of the trend engine processes event data to create topics, which are stored in a topic database 55 by the topic ID, topic header text, one or more trend metrics, and a set of features that define each topic. The features may be a vector of thousand of likelihood values corresponding to a distribution over thousands of features.

There is preferably more than one instance of the listening module active at any time, each optimized to monitor and scrape events from different online sources. Each instance logs the events to be sorted by trend and measured at a later date.

The events data may be part of a network maintained by the present system such that the diffusion of events throughout the network may be better observed by the trend engine. The data may also be taken from search queries or project description text entered by the user. New data objects created and connected to other objects by users are also examples of event data that are potentially trending.

The event data may be with respect to a data object which is posted and shared using a URL or hyperlink to that object. These data objects in a business graph may correspond to organizations, people, past projects, problems, solutions, services

The trend engine may pre-process the content and messages to detect features from hashtags, usernames, named entities (using Named Entity Recognition), extracted keywords (using TF-IDF and topic models), or tags and metadata associated with the data. This step reduces the massive stream of data to identify the features most likely to be relevant. Each features is paired with the time of the event (share, post, retweet, etc) to create time series data, such as table 1 of FIG. 4. The trend engine may create a vector of timestamps per features. Optionally the engine may record the data source.

Alternatively the time series data may be collected retrospectively, once a feature or object has been identified that passes a threshold number of events or because the system identifies a need from a new search query or new data object entered into the system.

The trend engine processes the time-series feature data to calculate a number of statistics. Example statistics include 1) the long-term baseline event rate 2) the moving average over the last X weeks (or months), 3) frequency spectrum (e.g. Fourier Analysis) and 3) first and/or second derivatives in time.

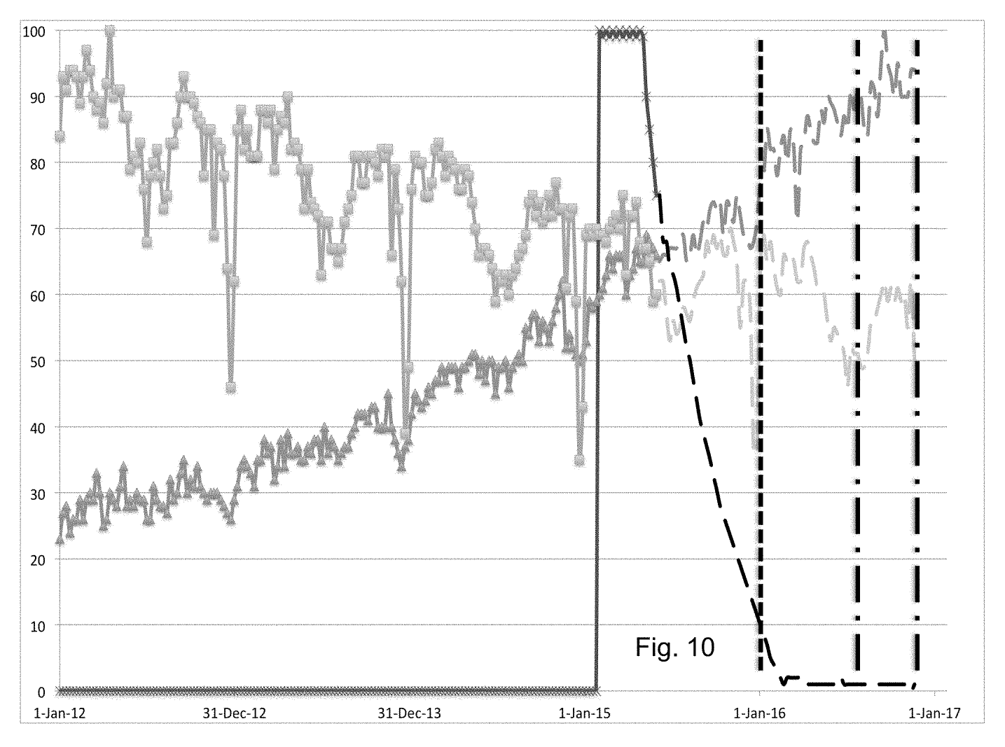

The trend engine may also fit a curve to the time series event data. The appropriate curve to fit may depend on the underlying human interest in the feature that causes it to be posted and shared. Some features may have a seasonal or cyclical nature, others changing slowly and linearly, whilst others explode exponentially. Thus the curve may be exponential, linear, polynomial or set of cosines. This is useful in order to reduce memory requirements by representing thousands of data points by a few coefficients of the equation. See time-series data of FIG. 10.

Time-series feature data may alternatively be described as a likelihood distribution of an event occurring. The Poisson distribution is an appropriate distribution for describing the number of times an event occurs in a window of time (days, weeks, months). Again the feature data requirements may be reduced, in this case to the parameter, lambda.

The curves or statistics may be normalized by the events for other features, especially features related to similar objects. For example, social posting of a new technology keyword may naively appear to indicate a huge increase in interest but the increase is on a small baseline and tiny compared to competing technology keywords. The trend engine attenuates the naïve trend to reflect this reality by dividing a trend metric by the average trend metric of related trends (for example, the average trend of all technology keywords).

The trend engine further processes the data to calculate impact scores used by the search engine's algorithms. The impact score may be viewed as an estimation of the impact of an object on a user in making a decision, particularly a decision to buy professional services. A first component of the impact score may be its popularity, corresponding to an average event of a feature. A second component may be the growth, indicating the increase or decrease in the event of a feature over a time period. The popularity or growth may be an observed event or a predicted event at some future date. The predicted event may be made from extrapolating the curve fitted to the data.

Unlike B2C recommendations and common search engines, where ranking is for immediate consumption, the present system in a B2B context tries to evaluate the impact of trends on a user at a future date when a decision is likely to be made. The future data may be a window of several days to weeks, beginning at a time days to weeks after a user's initial search session. Thus in certain embodiments, the trend engine calculates the predicted impact/trend/popularity score of a feature or data object at a future date Tw−, for a period W, up to date Tw+.

The window may be a fixed number of days and stored in a table, preferably stored with respect to search parameters, such as service requested. For example, the future date may be only 2 days for crises communications services but 100 days for accounting. This reflects the reality that certain services tend to be required immediately (or not), take a short/long time to decide, or are/are not influenced by trends. See FIG. 10.

The trend engine uses the modeled historical events to predict an event rate, and hence trend score, at the future date. From the curve fit to the historical events, the engine can extrapolate a future event rate and error range, or from the Poisson distribution the engine can predict a range of events that are likely more than a threshold chance.

The trend engine may apply a decay function to a present trend score to estimate a future trend score. This is useful when the recent event data takes the form of a higher than expected anomaly or the form of a pulse function, i.e. a sudden burst of events. In such a case, the number of future events is estimated to be low compared to the anomaly/pulse and the human memory of the anomaly/pulse will diminish over time. A decay function may be an exponential decay function, as shown in FIG. 10.

By modeling the time series of historical events (e.g. by curve fitting, Fourier analysis, or Poisson distribution) the trend engine can identify anomalies, which may indicate a new trend. From the model and enough historical data the trend engine can remove noise, account for expected cyclical variation, and calculate the statistical significance of an anomaly.

As shown in FIG. 5 the trend engine may periodically look for anomalies off-line or in response to user interest in a particular feature/object. The trend engine then retrieves the most recent time series data (from the past Y days), optionally processes the data over this recent period, and compares the recent events to events prior to Y days ago (or to the expected events over this recent period using the model) to calculate the differences. The difference may be an absolute/proportional change in events, change in growth rate of events, or change in frequency spectrum. The recent period to be considered may be a predetermined number of days, preferably the period used in the Poisson model or period for which a predetermined number of events exist.

The trend engine calculates whether the difference is significant in magnitude (compared to a threshold value) and whether it is significantly significant (considering the observed noise and normal fluctuations in the events). For significant and significantly significant recent activity, the trend engine calculates a trend score for the feature based on the amount of the magnitude and direction of the difference. This may be in addition to other contributions to the trend score, such as its absolute popularity.

Thus the system attempts to estimate the mental process of a user by monitoring human activity and modeling factors for human recall and decision-making.

The diffusion discussed above may be observed and recorded in the time domain to calculate trend metrics, from the diffusion proportion at time intervals. As discussed, the recognition module may model the diffusion for a defined network (or user attribute) as a) an absolute recognizability proportion or b) by fitting a curve of diffusion over time. Cyclical penetration models and decay functions are appropriate for certain features and objects that get forgotten, reposted, and re-shared, per the susceptible-infected-susceptible model.

FIG. 10 shows the events in time of users searching for three search keywords (“public relations” as light squares; “digital marketing” as dark triangles, and “Mog the Cat Xmas Ad,” as a black pulse), showing how keywords increase, decrease or cycle in popularity over time. When modeled, “public relations” comprises a yearly cycle, a 9% annual decrease and 15% noise. “Digital Marketing” has a 12% annual increase and 5% noise. The briefly popular “Mog the Cat” is modeled as a pulse with impact quickly dying through linear decay.

Thus the features are similarly impactful at search time (circa June 2015) but are predicted to have different impact at the decision window (1 Jan. 2016 to 1 Apr. 2016). Assuming the decision window is six months to nine months for the given search parameters, the trend engine extrapolates each feature's impact values (dashed curves) over this window and calculates the average impact value for each feature. One or more of the search results will be associated with these features and the impact values may be used by the search engine to rank the search results, preferably returning data indicating the association with features having high-impact scores.

### Associating Trends

Certain trends correspond exactly to a specific data object. This applies to events such as: social sharing of a link to a particular project; search for a known service, location or other attribute; or mention of a named entity in news/social media. In FIG. 5, trend topics ## are processed by the Association Module to determine one or more data objects that are related to each trend topic and stores the relationships from a topic id to a data object identified by data object ID and object type (org, service, relationship, problem, solution, project). In this case, topic 11 is matched using Named Entity Recognition to identify Project_ID1 from the 3-gram “Mog the cat” and the link to that object. Moreover the company names (Sainsbury's and AMV) and a service are identified which help to identify the business relationship object from the graph.

In certain other cases, a trend is identified that has no specific object in the business database (shown as a multi-type in FIG. 5). The association module may compare the features of the data objects to features of the trends to determine a similarity. In topic modeling feature comparison may be done by computing the F-divergence between two feature distributions. A data object may be tagged with several features or the features may be extracted from the images or text, from which the feature comparison can be made.

A single trend may also be associated with a both exactly corresponding data object and partially relevant data objects. For example, the trend association module may associate trend topic 11 with the “Mog the Cat” video objects and other video objects having the features “Christmas” and “Seasonal ads.”

Conversely the trend association module may associate a plurality of trend topics to one data object, meaning that the object is relevant to a plurality of trends.

### Ranking Objects Based on Trends

The search engine may use the trend engine's results 1) to interpret search queries, 2) to identify trending data objects relevant to the search and 3) to rank search results based on their connection to trending data objects. FIG. 9 shows a text query ## and three search results, each result shown with connected data objects.

In the first case, the search engine may process a search text string from query features to identify candidate data objects. Each candidate data object may have a plurality of possible matches with an associated confidence value. This is described in more detail in U.S. 62/406,418 filed 11 Oct. 2016

In the present system, the search engine modifies the confidence values using the trend scores, increasing the confidence scores for candidate objects that have high trend scores. The candidate objects with the highest confidence scores may be shown to the user as a suggestion to be selected, whereby the user-selection forms the search query. Alternatively, the search engine simple interprets the text query using the candidate data objects with the highest confidence.

The interpretation of the search query may be further refined by considering whether candidate objects relate to the same trend topic and/or considering the proximity of data objects in the database. In FIG. 9B, the project objects and the relationship object are proximate each other and relate to the same trend topic. Thus the search engine would increase the confidence scores of these candidate objects as interpretations of the search text.

In the second case, the search engine identifies second data objects connected to the search results and which are associated with trends topics. The second data objects are preferably also selected based on their relevance to the search query. P001 discussed how relevance scores may be calculated for client organizations based on their similarity to the search user's organization. P002 discussed how relevance scores of employees of organizations are calculated based of social proximity in a social network. Project object relevance may be scored from similarity of their features to the search parameters.

Alternatively the search engine may operate the topic model on the search query to identify one or more trend topics that are relevant to the search and then identify second data objects that are associated with these trend topics. These second data objects provide evidence that are relevant and popular.

In the third case, the search engine aggregates trend scores for data objects connected to each first data object (e.g. vendor) and to calculate a total trend score for each first object. The search engine then selects first data object partly based on the aggregated trend scores. Trend scores of data objects may be modified by their relevance score (above) and used to rank first and second data objects.

For a business services search engine, search results are viewed multiple times by the users. The results are likely viewed immediately after the initial search query then several times again until the end of the decision window. To improve the quality of the results, accounting for the temporal breadth, the search engine preferably ranks results based on the trend score at both the initial search time and over the decision window. This avoids the problem of organizations appearing as relevant and displayed now but irrelevant and not displayed in subsequent viewings of the same search. The search engine may record the trend scores at the time of the initial search query for later reuse and consistency in later results to that same user.

### Indexing

To reduce real-time computation delays, related features and data object IDs may be indexed to retrieve data objects associated with given features. The association is pre-processed offline and the index is searchable by the feature or another data object. For example, data objects may be indexed in order of relative recognizability/trending with respect to the feature, optionally stored with any pre-calculated trend/recognizability metrics. The associated data objects may be a mixture of organizations (clients, vendors, etc.), services, keywords, and past projects.

A transitive closure matrix may be stored to store the number of direct and indirect paths between vendors and data objects in the database 17. The search engine may lookup a given object to determine which vendors are associated with a data object and by how many paths. The number of paths provides a quick metric for the evidence for this vendor-object connection, as stored in the full graph.

### Display

The system receives queries and communicates results to users via a user interface on the user's computing device. The system prepares web content from the vendor and evidence data objects. A serialization agent serializes the web content in a format readable by the user's web browser and communicates said web content, over a network, to a client's or vendor's computing device.

Display to a user means that data elements identifying an object are retrieved from a data object in the database, serialized and communicated to user device 10 for consumption by the user. The communication may include identifying attributes (e.g. names, brands), the text from a document, or a multi-media file (e.g. JPEG, MPEG, TIFF) for non-text samples of project. The system preferably comprises a web server to serve a client computer remotely. The web server receives and sends data from the client computer operated by a user.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” and “I” (the slash mark) between alternatives is to be understood in the inclusive sense, whereby either alternative and both alternatives are contemplated or claimed.

Reference in the above description to databases are not intended to be limiting to a particular structure or number of databases. The databases comprising documents, projects, business relationships or social relationships may be implemented as a single database, separate databases, or a plurality of databases distributed across a network. The databases may be referenced separated above for clarity, referring to the type of data contained therein, even though it may be part of another database. One or more of the databases and modules may be managed by a third party in which case the overall system and methods or manipulating data are intended to include these third party databases and agents.

For the sake of convenience, the example embodiments above are described as various interconnected functional agents. This is not necessary, however, and these functional agents may equivalently be aggregated into a single logic device, program or operation. In any event, the functional agents can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

The terms “first” and “second” is not intended to denote an ordering or sequence but is rather for consistent identification of items. Thus, the phrases “first object” and “second object” do not necessarily mean that the first object is created, manipulated or retrieved before the second object. Rather, these phrases are used to identify different sets of objects.

Headings are for convenience only; information on a given topic may be found outside the section indicating a certain topic.

1. A computer-implemented method comprising:
identifying a set of first data objects in a graph database that satisfy a search query;
identifying second objects that are connected to the first objects in the graph database;
calculating one or more recognizability metrics for the second objects using a recognition model;
ranking the first data objects based on the recognizability metrics of their connected second data objects; and
communicating a subset of the first data objects as search results based on the rankings.

2. A computer-implemented method of building and storing a recognition model comprising;
selecting a data object from a graph database comprising connected data objects representing projects, users, and organizations with respect to provision of business services;
retrieving identification data from the data object;
searching third party websites for content items comprising features matching the identification data;
determining attributes of an audience of each content item;
creating a recognition model from the aggregated attributes of the audiences and linking the selected data object with the recognition model in a database, whereby the recognition model calculates a recognizability score for the selected data object given attributes of a user or their search query.

3. The method of claim 1, wherein the first objects are further ranked based on the relevance of each connected second object to the search query.

4. The method of claim 1, further comprising calculating a trend metric using time-series analysis and the first objects are further ranked based on a trend metric of each connected second object.

5. The method of claim 1, wherein the recognition model is a weighted comparison of attributes of the data object and attributes of the user or their search.

6. The method of claim 1, wherein the search query relates to business services to be provided.

7. The method of claim 2, wherein the recognition model is a weighted comparison of attributes of the data object and attributes of the user or their search.

8. The method of claim 2, wherein the search query relates to business services to be provided.

9. The method of claim 1 wherein identifying second objects that are connected to the first objects in the graph database comprises looking up the first objects in a transitive closure matrix storing the number of direct and indirect paths between first and second objects.

10. The method of claim 1, wherein the recognition model comprises an infection model to calculate the recognizability metrics with regard to observed knowledge of second data objects by users within a social network.
